(19) United States
(12) Patent Application Publication
(10) Pub. No.: US 2006/0020545 A1
(43) Pub. Date: Jan. 26, 2006

(54) Payroll system

(75) Inventors: David I. Lindheimer, Mercer Island, WA (US); Anthony J. Seeley, Redmond, WA (US); David J. Brankin, Redmond, WA (US)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/899,872

(22) Filed: Jul. 26, 2004

(51) Int. Cl. G06Q 40/00

(52) U.S. Cl. 705/40

(57) ABSTRACT

The present invention provides a payroll system in which calculations are performed by a remote service, but where the client maintains access to, and control over, payroll and employee records. In one embodiment, a client component receives a user request for a payroll calculation and populates data transmission schemas with data required for the payroll calculation. The data transmission schemas are provided to a service component which invokes calculation components for performing the payroll calculations. The service component then returns the results of the payroll calculations to the client component. The present invention thus effectively decouples the location where payroll calculations are performed and where the payroll and employee data resides.

### BACKGROUND OF THE INVENTION

The present invention relates to a payroll calculation system. More specifically, the present invention relates to a distributed payroll calculation system. This provides advantages associated with both outsourced and local payroll solutions, while reducing the disadvantages associated with those two types of systems.

Solutions provided by prior payroll systems have generally broken down into two different categories, outsourced payroll solutions and local payroll solutions. Each of these solutions provide advantages and disadvantages.

In an outsourced solution, all of the payroll calculations are performed by a remote service provider. Therefore, when the customer for which the payroll services are being provided sets up an account with a payroll service provider, the customer sends to the payroll service provider (usually by telephone or telefacsimile) relevant records of employees for which payroll is to be calculated. Those records include, for instance, a complete identification of the employee including the employee's address, the pay rate for the employee, various deductions (such as pre-tax and post-tax deductions) which the employee desires to make, tax withholding information for each employee, etc. During each pay period, the payroll service provider calculates the payroll and may provide additional ancillary services, such as check printing. The results of the payroll calculation and ancillary services are provided back to the customer, as a service.

The outsourced solution has a number of advantages. For instance, all calculations are performed in a central location. Therefore, for the service provider, as tax updates or other payroll calculation updates are performed, those updates do not need to be propagated to individual customers. Instead, the software can simply be updated at the centralized processing location.

However, the outsourced solution also has a number of disadvantages. Once the customer transmits all of the employee data to the service provider, the customer no longer has access to that copy of the information. Each time an employee's information is changed or modified, the modification must be accurately transmitted from the customer to the service provider. All records must be accurately maintained by the service provider. This is error prone.

In addition, if the customer desires to run additional reports on the payroll data, the customer must request that of the payroll service provider. Since the customer has no access to the payroll records, the customer cannot, of its own volition, run additional reports on that data.

Similarly, the outsourced solution does not integrate well with the customer's existing systems. Instead, the two systems are completely separate and integration for calculation or reporting purposes is very difficult.

Further, the outsourced solution provides timing constraints on the customer. The customer is no longer in control of when payroll is run, but instead must comply with deadlines imposed by the payroll service provider.

The second payroll solution, the on-premises or local software solution, is a solution in which the customer receives and maintains payroll software at its location. The payroll software is used to run payroll calculations for the customer.

This type of solution has a number of advantages. First, all of the payroll records and employee data are maintained locally at the company. Therefore, two sets of payroll records and employee data need not be maintained. Similarly, the company has immediate access to the payroll data and employee records. Therefore, additional reporting or calculations can be performed without needing to request that information from a service provider.

However, the local solution also has a number of disadvantages. From the standpoint of the software vendor, the local solution requires constant shipment of tax and other updates to the customer. The customer must then have the expertise to install the updates, or to modify the existing software to accommodate the updates. Similarly, the local solution requires a certain level of expertise in order to implement business logic associated with the payroll calculations. This can be costly and labor intensive.

### SUMMARY OF THE INVENTION

The present invention provides a payroll system in which calculations are performed by a remote service, but where the client maintains access to, and control over, payroll and employee records. In one embodiment, a client component receives a user request for a payroll calculation and populates data transmission schemas with data required for the payroll calculation. The data transmission schemas are provided to a service component which invokes calculation components for performing the payroll calculations. The service component then returns the results of the payroll calculations to the client component. The present invention thus effectively decouples the location where payroll calculations are performed and where the payroll and employee data resides.

Another embodiment of the present invention includes the specific transmission schemas used to send data between the client and service components.

The present invention can also include an updating system. In that embodiment, either one or both of the client component and service component act separately or together to determine whether the transmission schemas need to be updated in order to accommodate modified payroll calculation rules (e.g., in order to provide additional or different data required for a modified payroll calculation). If so, the data transmission schemas used by the client component are updated to a current version to reflect the modified payroll calculations.

### BRIEF DESCRIPTION OF THE DRAWINGS

FIG. 1 is a block diagram of one illustrative environment in which the present invention can be used.

FIG. 2 is a block diagram of an illustrative payroll system in accordance with one embodiment of the present invention.

FIG. 3 is a flow diagram illustrating a service setup operation in accordance with one embodiment of the present invention.

FIG. 4 is a flow diagram illustration of an employee or company location setup operation in accordance with one embodiment of the present invention.

FIGS. 5A and 5B illustrate a synchronous pay calculation process in accordance with one embodiment of the present invention.

FIGS. 6A and 6B illustrate an asynchronous payroll calculation operation in accordance with one embodiment of the present invention.

Appendix A illustrates data transmission schemas used in accordance with one embodiment of the present invention, and gives examples of such schemas.

### DETAILED DESCRIPTION OF ILLUSTRATIVE EMBODIMENTS

The present invention deals with a payroll calculation system. However, before describing the present invention in greater detail, one embodiment of an illustrative environment in which the present invention can be used will be described.

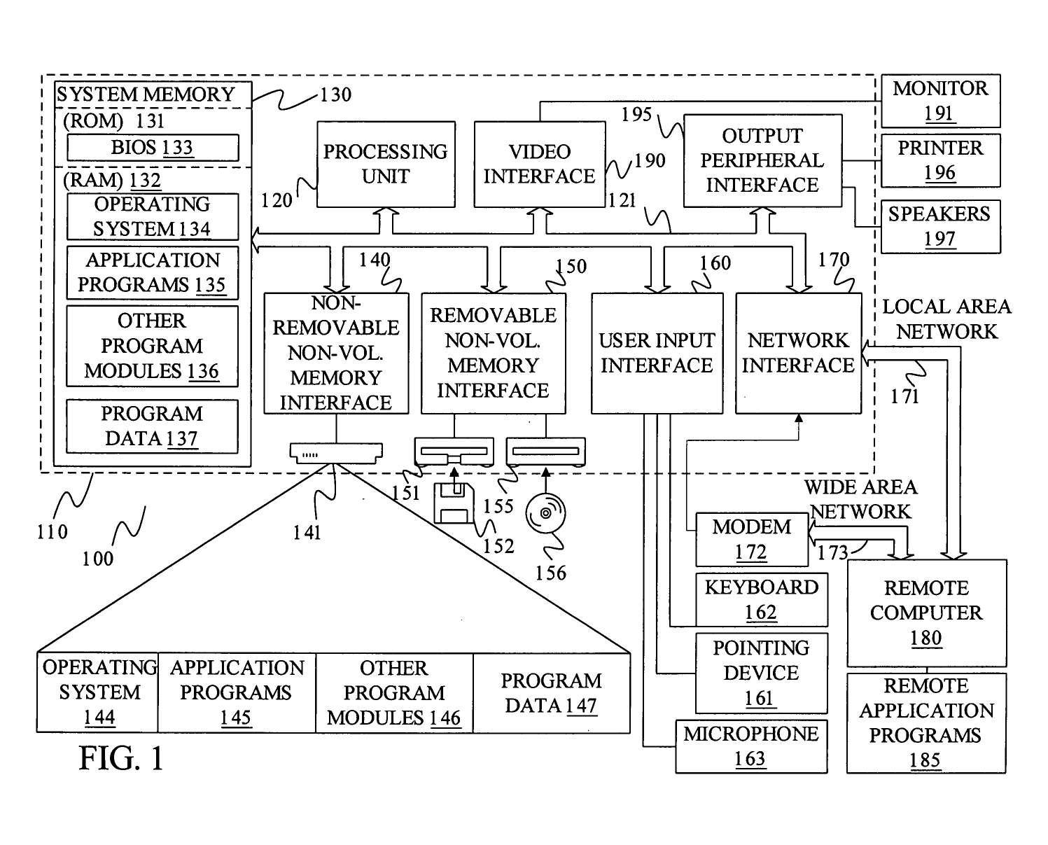

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

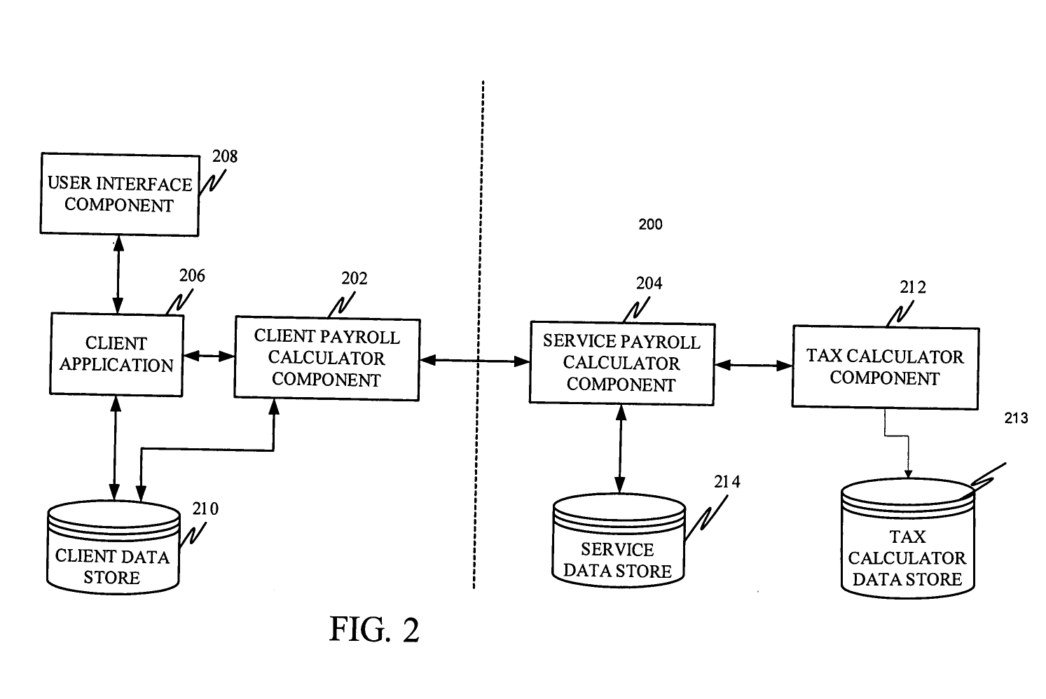

FIG. 2 is a block diagram of one illustrative embodiment of a payroll calculation system 200 in accordance with one embodiment of the present invention. System 200 illustratively includes a client payroll calculator component 202, and a service payroll calculator component 204. Client component 202 is shown operably connected to a client application 206 that uses a user interface component 208 for receiving inputs and providing outputs to a user. Application 206 and client component 202 are also shown with access to client data store 210. Service component 204 is shown connected to an optional tax calculator component 212 (that is, in turn, connected to a tax calculator data store 213) and service data store 214.

In general operation, client component 202 is installed at a company's location that wishes to have payroll calculated. The client component 202 undergoes a setup process during which information is passed to service component 204 so the client can subscribe to the payroll calculation services.

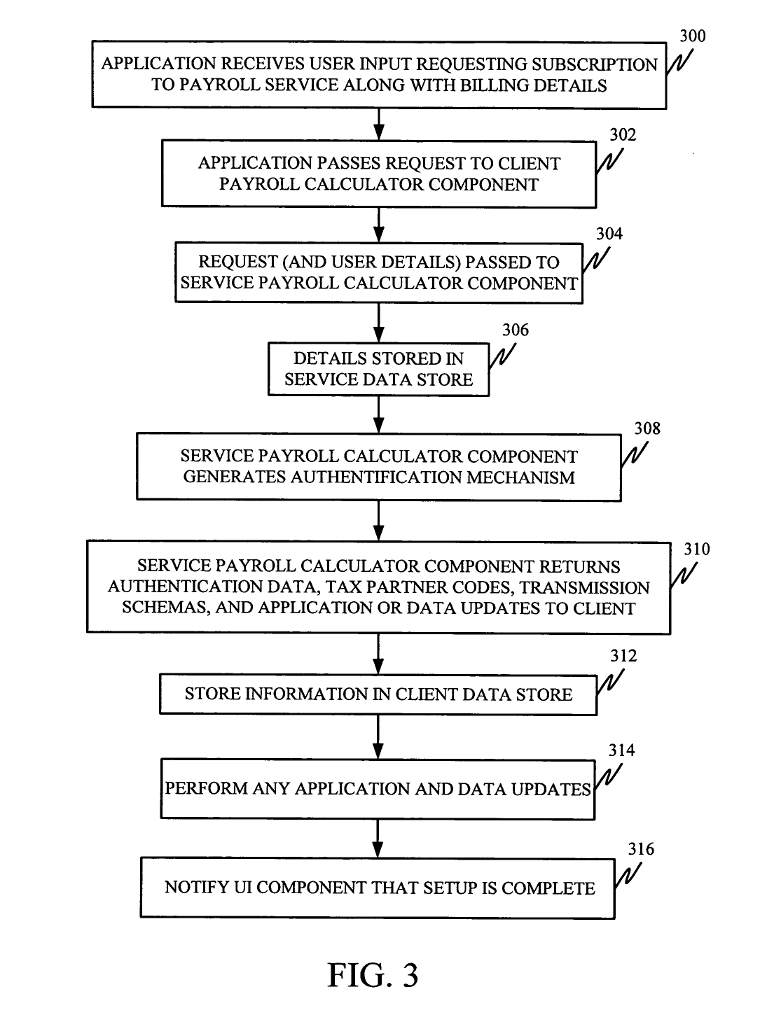

Once the setup process is complete, a user can request through user interface 208 and client application 206, that a payroll calculation be performed. Client component 202 gathers necessary information from data store 210 and provides it to service component 204, along with a request that a payroll calculation be performed. Service component 204 can perform all pre-tax calculations, tax calculations, and post-tax calculations on its own, or it can invoke calculator components (such as component 212) to perform some or all of the calculations. When the payroll calculations are complete, the results are passed back to client component 202 for presentation to the user. These processes are described in greater detail below with respect to FIGS. 3-6B.

FIG. 3 is a flow diagram illustrating the operation of system 200 in accordance with one embodiment of a setup process. In order for a customer to undergo the setup process and subscribe to receive payroll calculation services, client component 202 is first downloaded and installed on the customer's system. This can, of course, be deployed with the application, such as on a compact disc or other storage medium, or it can be downloaded over a network. The application then receives a user input from user input component 208 requesting subscription to the payroll services. The user also inputs to application 206 (through user input component 208) billing details indicating where and how the customer wishes to be billed. This is indicated by block 300 in FIG. 3. Application 206 then passes the subscription request to client payroll calculator component 202. This is indicated by block 302.

Client component 202 then passes the request and associated billing details to service payroll calculator component 204. This is indicated by block 304. Service component 204 then stores the billing details in service data store 214. This is indicated by block 306 in FIG. 3. Providing billing details is optional.

Service component 204 then produces an authentication mechanism for use with the customer. The particular authentication mechanism can take any desirable form, such as a digital certificate or a user name and password, or any other suitable authentication mechanism. This is indicated by block 308 in FIG. 3. Authentication is optional.

Service component 204 then returns data to client component 202. The data returned illustratively includes the authentication mechanism, transmission data schemas, tax codes, and any updated application components (such as payment codes, report structures, etc.).

The tax codes are illustratively codes used by service component 204 (or associated calculator components) to represent the tax jurisdictions associated with a given customer or employee. For instance, in some venues (such as North America) it can be very important to determine the jurisdiction where an employee or company resides and works in order to determine how that employee or company is taxed. Identifying a proper tax jurisdiction can involve more than simply passing in a zip code or other address. By way of example, a single zip code may have multiple tax jurisdictions. Some common tax jurisdictions include township, county, city, school district, Unincorporated Territory, etc. Each of these jurisdictions can require a different tax treatment. Therefore, the residence and work location of an employee and company are passed into service component 204 and component 204, in turn, passes back a tax code that is used in subsequent payroll calculations for the identified employee or company.

Of course, the code is not needed. Instead, every time a calculation is desired, the entire address and jurisdiction information can be passed from the client component 202 to the service component 204. However, representing that information with a code reduces the amount of throughput data and makes the transmissions easier. In addition, if service component 204 is unable to identify the particular jurisdiction based on the address (such as where more than one tax jurisdiction could apply) service component 204 illustratively provides all jurisdictions that may apply back to client component 202. Client component 202 then provides those possibilities back through client application 206 and user input component 208 to the user. The user can then select the appropriate tax jurisdiction from those available. In response, service component 204 provides the appropriate code to client component 202. In this way, the tax jurisdiction is disambiguated, and the appropriate code is identified. By using the selected code for subsequent calculation requests, there is no need to query the user each time a request is made to disambiguate the tax jurisdiction.

The same process can be used when a tax code is retired. Tax codes can be retired for a variety of reasons. For instance, when a tax jurisdiction is split into two jurisdictions, the old tax code may be retired in favor of two new ones. The system can then query the user to choose one of the new tax codes.

Schemas, in general, define the way in which components access, or communicate with, one another. The data transmission schemas are illustratively markup language documents (such as XML documents) or other schemas that define the data, and the format of the data, which is required by service component 204 and associated calculator components, in order to perform the payroll calculation. The transmission schemas can take any of a wide variety of forms. However, one illustrative transmission schema is set out in Appendix A attached hereto. Appendix A describes an XML format for messages passed between service component 204 and client component 202, in accordance with one embodiment of the invention. Of course, the message can be compressed as desired. Returning the authentication data, tax codes and transmission schemas and updates is indicated by block 310 in FIG. 3.

Once the information is provided from service component 204 back to client component 202, client component 202 stores the information in client data store 210 where it can be accessed by application 206 and client component 202. Storing the information in the data store is indicated by block 312 in FIG. 3.

Client component 202 then performs any necessary application updates based on the update information returned by service component 204. This is indicated by block 314 in FIG. 3.

Finally, client component 202 notifies application 206 that the setup operation is complete and application 206 provides user interface component 208 with an indication that is used to inform the user that the setup is complete. This is indicated by block 316 in FIG. 3.

After the setup is complete, it may happen that a new employee joins the customer, or the customer changes its company work location or adds an additional company work location. In that case, an employee or company location setup process is performed.

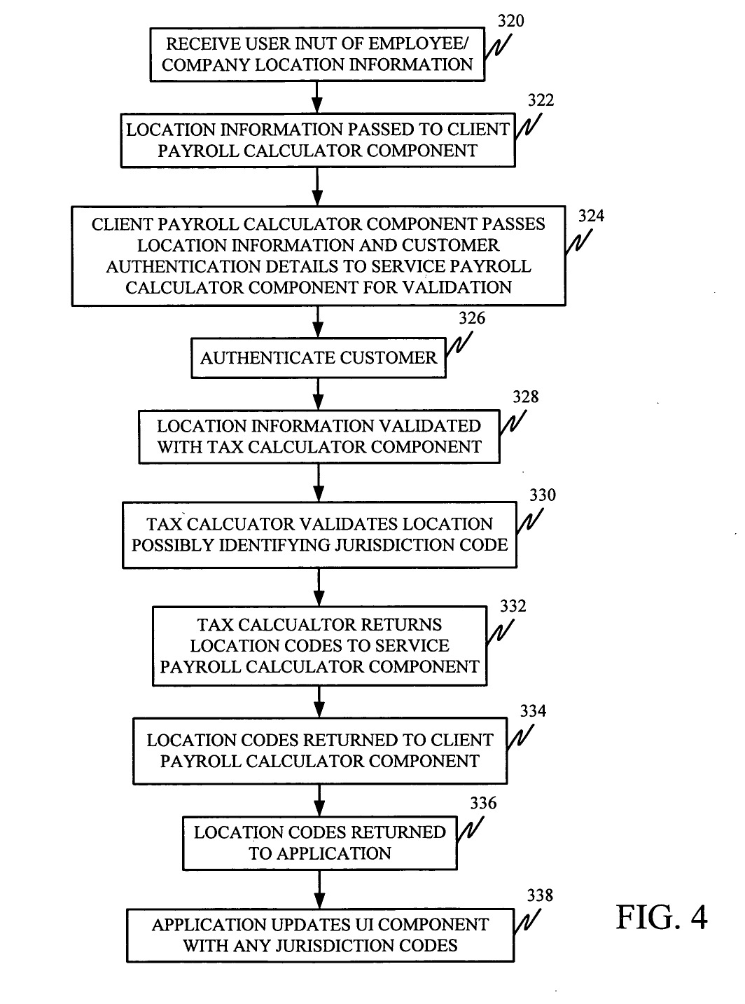

FIG. 4 is a flow diagram illustrating one embodiment of the employee and company location setup process. The client application 206 first receives through user interface component 208 a user input of the employee/company location information. This is indicated by block 320 in FIG. 4. The information is used to identify an associated tax jurisdiction and other pertinent information.

Next, the location information for the new employee or new customer work location is passed from client application 206 to client payroll calculator component 202. Component 202, in turn, passes the information to component 204, along with customer authentication information generated during the setup process. These steps are indicated by blocks 322 and 324 in FIG. 4.

Component 204 authenticates the customer before the location information is validated. This is indicated by block 326 in FIG. 4.

After the customer is authenticated, the location information just passed to component 204 is validated with tax calculator component 212. In validating the location information, the tax calculator component 212 returns, if necessary, an additional jurisdiction code corresponding to the location information. Again, it will be appreciated that tax calculator component 212 can be integral with service component 204, or separate and provided by a different service provider. In any case, validation of the location information is indicated by blocks 328 and 330 in FIG. 4.

Once the additional jurisdiction codes (or location codes) are returned from tax calculator component 212 to service component 204, they are then transmitted back to client component 202. This is indicated by blocks 332 and 334 in FIG. 4.

Client component 202, returns the location codes to application 206. Application 206, in turn, updates user interface component 208 with the returned location codes. This is indicated by blocks 336 and 338 in FIG. 4.

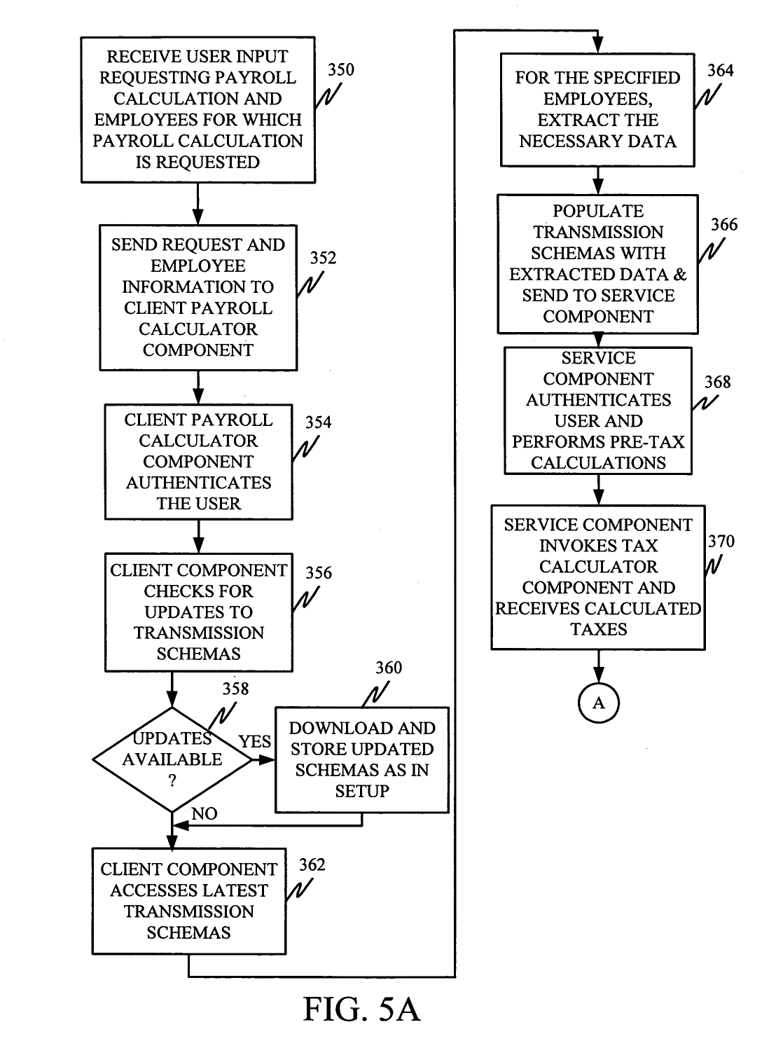

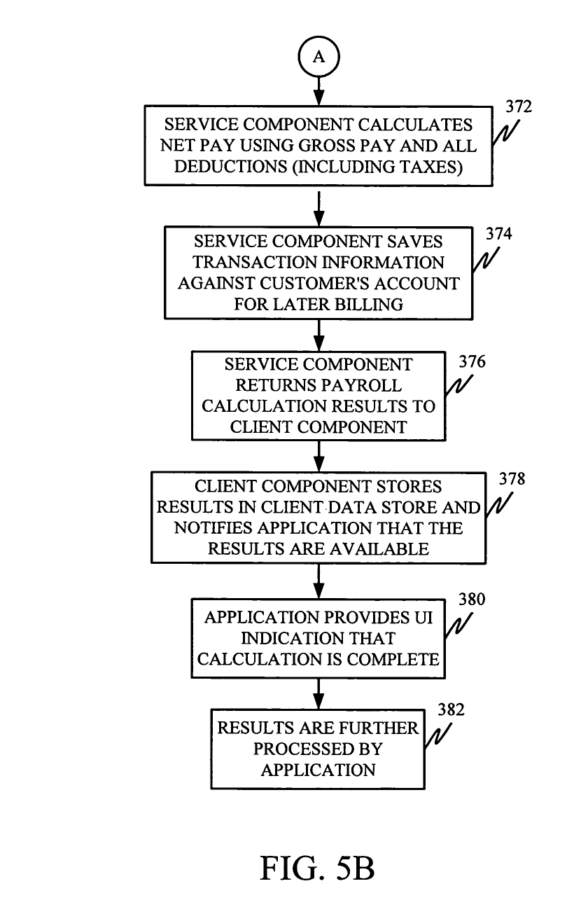

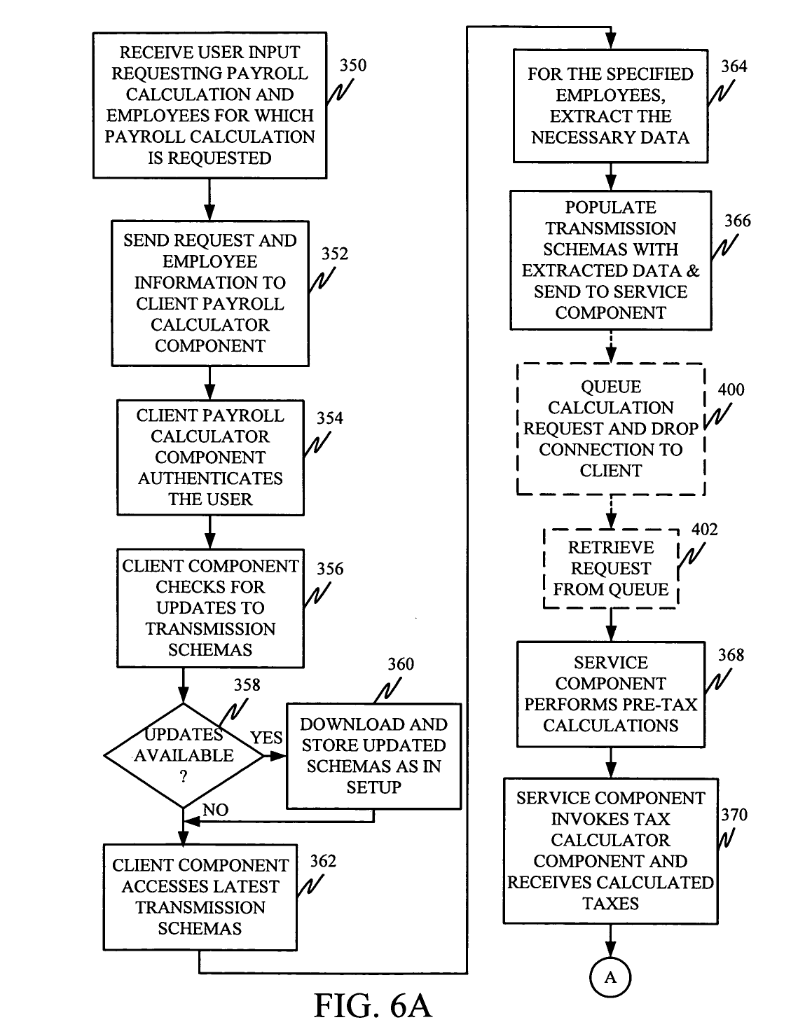

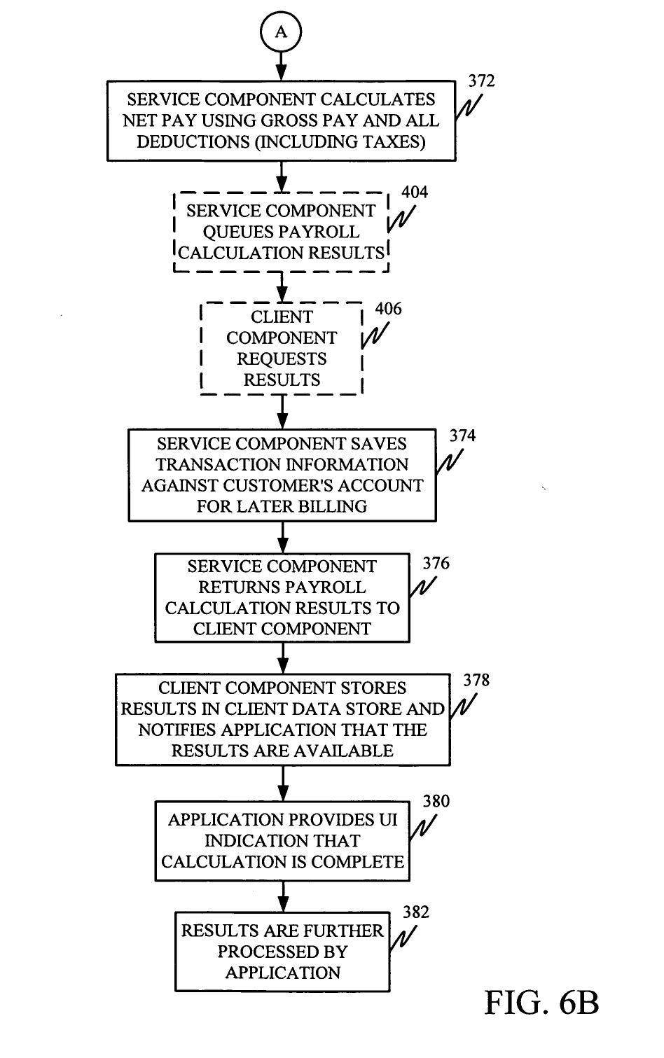

After the setup process has been completed, and after any new employees or locations are updated, system 200 is configured to perform payroll calculations for the customer. FIGS. 5A and 5B (collectively referred to as FIG. 5) illustrate a flow diagram for a synchronous pay calculation process in accordance with one embodiment of the present invention. By synchronous, it is meant that a connection between client component 202 and service component 204 is maintained during the payroll calculation process. In an asynchronous process, the connection is dropped once a payroll calculation request is made by the client, and it is re-opened when requested by the client. If the results of that calculation are ready, they are returned to the client. If not, this is indicated to the client and the client then requests them later. The asynchronous process is described in greater detail below with respect to FIGS. 6A-6B.

In any case, in the synchronous process, user interface component 208 first receives a user input requesting a payroll calculation. The request illustratively identifies the employees for which the payroll calculation is requested. The employees may include all of the employees for the customer, or any given subset of those employees identified by range, or employees specifically identified or listed in another way. This is indicated by block 350 in FIG. 5.

The request is provided through user interface component 208 to client application 206 where it is passed to client component. 202. This is indicated by block 352. Client component 202 then determines whether there have been any updates to the transmission schemas used to pass data to service component 204 for a payroll calculation. This is indicated by block 356. For instance, since the last payroll calculation request by the client, the tax codes or tax jurisdictions may have changed. In making such changes, the service component 204 may require additional or different information in order to perform a payroll calculation for the customer. In that case, the transmission schemas used to transfer data are updated such that the appropriate data is collected in order for the payroll calculation to be accurately and correctly performed. If updates are available, then service component 204 transfers the updated transmission schemas to client component 202 where they are stored in client data store 210 in a fashion similar to that described with respect to the setup process. Downloading available updates is indicated by blocks 358 and 360 in FIG. 5.

If no updated transmission schemas are available, or if they are available and have been downloaded, client component 202 accesses the latest transmission schemas from client data store 210. This is indicated by block 362.

For the specified employees (for which the payroll calculation is to be performed) client component 202 then extracts the necessary data to populate the data transmission schemas. This is indicated by block 364. Client component 202 then populates the transmission schemas with the extracted data and sends the populated transmission schemas to service component 204. This is indicated by block 366 in FIG. 5.

The extracted data will illustratively include employee details, such as tax withholding information, residential and working location codes (or jurisdiction codes), a payment amount or payment rate, deductions and benefits along with all necessary year-to-date figures such that service component 204 and its associated calculator components can perform the desired payroll calculation.

Upon receiving the request and transmission schemas, service component 204 first authenticates the user and then performs all pre-tax calculations required for the overall payroll calculation. This is indicated by block 368. Service component 204 illustratively includes a rules engine that defines the order of deductions and how they are applied to the gross pay amount and post-tax amount.

Some examples of pre-tax calculations include pre-tax deductions for deductible items and accretions for income, such as 401K or other retirement benefit contributions, medical or other non-retirement benefit accretions or deductions, such as commissions, bonuses, etc. These amounts are all used to adjust the gross taxable pay amount. In addition, it will be appreciated that client component 204 may receive a gross amount of pay allocated to an identified employee. In that case, all the pre-tax deductions are simply deducted from the gross pay amount. In contrast, however, service component 204 may receive a pay rate (such as dollars per hour) along with an amount of time worked, and service component 204 will calculate the gross pay amount from those figures. Of course, any other such pre-tax calculations can be performed by service component 204 as well.

Once all of the pre-tax calculations have been performed, service component 204 will have arrived at a taxable figure. Service component 204 thus invokes tax calculator component 212 which calculates the taxes based upon the jurisdiction codes provided and the taxable amount provided. Tax calculator component 212 then returns the calculated tax information, indicating taxes due, to service component 204. This is indicated by block 370 in FIG. 5.

Service component 204 then performs all post-tax calculations. Such calculations can include deducting the taxes from the taxable amount, and showing all other post-tax deductions from the ultimate payroll amount. This is indicated by block 372 in FIG. 5.

After performing the post-tax calculations, service component 204 saves transaction information, corresponding to the payroll calculation services just performed, against the customer's account in service data store 214. This transaction information is used for purposes of generating a bill to the customer for the payroll calculation services for which the customer has subscribed. This is indicated by block 374. Of course, billing is carried out as specified by the customer during setup.

Service component 204 then returns the payroll calculation results to client component 202.

Client component 202 stores the calculation results in the application data store 210 and notifies application 206 that the results are available. This is indicated by blocks 376 and 378 in FIG. 5. The application 206 then provides user interface component 208 with an indication that the calculation is complete. The results can then be further processed by client application 206, as desired. This is indicated by blocks 380 and 382.

Of course, further processing steps can take any form desired by the user and implemented by application 206. Examples of such processing can include check printing, notifying a bank for automatic withdrawal or automatic deposit, etc. Of course, these processing steps can also be performed by client component 202, in another embodiment.

FIGS. 6A and 6B (collectively referred to as FIG. 6) illustrate a process for providing asynchronous payroll calculation services. It can be seen that FIG. 6 is the same as FIG. 5 except for a plurality of additional blocks 400, 402, 404, and 406. Again, in the asynchronous process, client component 202 requests payroll calculations to be performed by service component 204 and provides the necessary transmission schemas, and then disconnects the link to service component 204. Service component 204, in turn, queues the request in an in-bound queue and processes it in due course. The results are then placed in an out-bound queue for client component 202. Providing the results to client component 202 can be performed according to either a push model or a pull model. In the push model, service component 204 initiates the link to client component 202 and transmits the results to client component 202. In the pull model, client component 202 initiates the link to service component 204 and requests the results. If they are ready, then in response to the client's request, the results are transmitted from service component 204 to client component 202. If the results are not ready, this is indicated to the client so the client can request the results later. In either the push model or the pull model, the queues associated with the asynchronous process can be provided in service data store 214 or in a separate database, or as part of service component 204 or a separate component.

It can be seen that much of the processing shown in FIG. 6 is the same as that shown in FIG. 5 and will not be discussed again. However, after client component 202 has populated the necessary data transmission schemas at block 366, and has sent those transmission schemas along with a payroll calculation request to service component 204, service component 204 then queues the request and associated information and returns a handle to client component 202. Passing the handle confirms that service component 204 has received the request, and the handle provides a request handle that client component 202 can use later to request results of the calculation. Client component 202 then drops the connection to service component 204. This is indicated by block 400 in FIG. 6.

Then, at an appropriate time (either in a first-in first-out order, or another desired order) service component 204 retrieves the request and associated data from the input queue. This is indicated by block 402 in FIG. 6. Next, that information is processed as discussed with respect to FIG. 5 and blocks 368-372.

It should also be noted that multiple service components 204 can be provided to service the input queue. The multiple service components 204 can be implemented by multiple processes or multiple computers. This provides enhanced scalability.

After the final payroll calculations have been performed, service component 204 then queues the payroll calculation results in an out-bound queue. This is indicated by block 404 in FIG. 6. When client component 202 is ready to receive the results (either according to the push model or the pull model) service component 204 retrieves the results from the out-bound queue and transmits them to client component 202. This is indicated by block 406. Again, processing resumes as described with respect to blocks 374-382 in FIG. 5.

It will be appreciated that the functions assigned to the client and service provider can be distributed differently between them than as specifically described herein. This can be done while still employing the inventive aspects of the invention.

It can thus be seen that the present invention provides a number of significant advantages over prior systems. The present invention provides the customer with control over, and access to, the employee and payroll records for its company and employees. However, the customer need not repetitively receive and install updated calculation components to reflect updated law and tax codes. Instead, the transmission schemas are simply updated and those are periodically downloaded, as needed, automatically by client component 202 and service component 204. Therefore, the customer can run any desired reports on the employee and payroll records without requesting a service provider to run those reports (and without paying the service provider additional monies to run those reports).

Further, there are no deadlines imposed by the service provider on service calculations. Instead, the customer can simply request that a calculation be performed for designated employees, at any time, and the calculations are performed by the service provider.

In addition, since the client maintains access to the payroll data, the customer need not maintain duplicate copies of the same data at its facilities and those of the service provider. Instead, the customer need only maintain a single copy of that data. Similarly, since client component 202 resides with the customer, the system 200 is designed to integrate well with existing customer applications and computer systems.

Further, the service provider need not maintain customer records. Instead, the necessary data is simply transmitted in the transmission schema each time a payroll calculation is to be performed. The data is only held by the service provider as long as it is needed for the tax calculation. It is then discarded by the service provider. Of course, some information (such as the employee identifier) is maintained by the service provider until the results are received by the client in the asynchronous approach. Also, all the information, some of it, or some miscellaneous information (for billing, bug or fraud detection, etc.) can also be maintained.

Also, as tax codes change, or other payroll calculation rules change, the service provider need not send out constant updates to the: customers. Instead, the components on the service provider are simply updated as needed. Thus, the present invention is highly advantageous over prior systems.

Although the present invention has been described with reference to particular embodiments, workers skilled in the art will recognize that changes may be made in form and detail without departing from the spirit and scope of the invention.

What is claimed is:

1. A method of generating payment information for a client indicative of payments to be made, comprising:
each time payment information is to be generated, receiving, from a client component, identification information identifying an entity to receive the payment and basis information indicative of a basis for the payment;
generating, at a service component, the payment information based on the received identification information and the received basis information, the received identification information and the received basis information comprising all information, specific to the entity, that is located at the service component for generation of the payment information; and
returning the payment information to the client component.

2. The method of claim 1 wherein the payment information comprises payroll information and wherein receiving basis information comprises:
receiving gross pay amount information indicative of a gross pay associated with the identified entity.

3. The method of claim 2 wherein receiving gross pay amount information comprises:
rate information indicative of a payment rate for the identified entity; and
time information indicative of an amount of time to which to apply the payment rate to obtain the gross pay associated with the identified entity.

4. The method of claim 2 wherein receiving gross pay amount information comprises:
receiving the gross pay associated with the identified entity.

5. The method of claim 2 wherein receiving basis information comprises:
receiving adjustment information indicative of additions or subtractions to be made to the gross pay associated with the identified entity.

6. The method of claim 5 wherein receiving adjustment information comprises:
receiving a tax identifier indicative of a tax treatment associated with the identified entity.

7. The method of claim 6 wherein receiving the tax identifier comprises:
receiving a tax jurisdiction identifier identifying a jurisdiction under which the identified entity is taxed.

8. The method of claim 6 wherein receiving the tax identifier comprises:
receiving a tax code identifier identifying a tax code pursuant to which the identified entity is taxed.

9. The method of claim 6 wherein generating the payment information comprises:
invoking a tax calculator component to calculate taxes based on the tax identifier.

10. The method of claim 9 wherein invoking the tax calculator comprises:
invoking an external tax calculator component, external to the service component.

11. The method of claim 9 wherein invoking the tax calculator comprises:
invoking an internal tax calculator component, internal to the service component.

12. The method of claim 5 wherein generating the payment information comprises:
invoking an adjustment rules engine to make adjustments to the gross pay, in a desired order, based on the received adjustment information.

13. The method of claim 12 wherein invoking the adjustment rules engine comprises:
making pre-tax adjustments to the gross pay based on received pre-tax adjustment information.

14. The method of claim 12 wherein invoking the adjustment rules engine comprises:
making post-tax adjustments to the gross pay based on received post-tax adjustment information.

15. The method of claim 12 wherein invoking the adjustment rules engine comprises:
adjusting the gross pay based on taxes due.

16. The method of claim 1 wherein receiving identification information and basis information comprises:
receiving the identification information and basis information in a populated data transmission schema.

17. The method of claim 16 and further comprising:
prior to receiving the populated data transmission schema, determining whether the client component has an updated data transmission schema; and
if not, updating the data transmission schema on the client component.

18. The method of claim 1 and further comprising:
saving transaction billing information, indicative of generating the payment information at the service component, in a service data store for generation of a bill.

19. A method of generating payroll information for a client indicative of payments to be made, comprising:
receiving a populated data transmission schema from a client component, the populated data transmission schema including identification information identifying an entity to receive the payment and payroll amount information;
generating, at a service component, the payroll information based on the identification information and the payroll amount information; and
returning the payroll information to the client component.

20. The method of claim 19 wherein the payroll amount information comprises:
gross pay amount information indicative of a gross pay associated with the identified entity.

21. The method of claim 19 wherein the payroll amount information comprises:
rate information indicative of a payment rate for the identified entity; and
time information indicative of an amount of time to which to apply the payment rate to obtain the gross pay associated with the identified entity.

22. The method of claim 19 wherein receiving payroll information comprises:
receiving adjustment information indicative of adjustments to be made to a gross pay associated with the identified entity.

23. The method of claim 22 wherein receiving adjustment information comprises:
receiving a tax identifier indicative of a tax treatment associated with the identified entity.

24. The method of claim 23 wherein generating the payroll information comprises:
invoking a tax calculator component to calculate taxes based on the tax identifier.

25. The method of claim 24 wherein generating the payroll information comprises:
invoking an adjustment rules engine to make adjustments to the gross pay, in a desired order, based on the received adjustment information.

26. The method of claim 19 and further comprising:
prior to receiving the populated data transmission schema, determining whether the client component has an updated data transmission schema; and
if not, updating the data transmission schema on the client component.

27. A method of generating payment information for indicative of payments to be made by a client, comprising:
receiving a user input requesting generation of the payment information for an identified entity;
extracting, from a data store, identification information identifying an entity to receive the payment and basis information indicative of a basis for the payment;
transmitting the extracted information to a service component for generation of the payment information based on the identification information and the basis information; and
receiving the payment information from the service component.

28. The method of claim 27 wherein transmitting comprises:
populating a data transmission schema with the extracted information; and
transmitting the populated data transmission schema to the service component.

29. The method of claim 28 and further comprising:
prior to populating the data transmission schema, downloading any updated data transmission schema required by the client component.

30. The method of claim 27 and further comprising:
prior to receiving a user input requesting generation of payment information, transmitting set-up information to the service component.

31. The method of claim 30 wherein the set-up information comprises:
billing detail information and client identifier information.

32. The method of claim 31 and further comprising:
receiving from the service component authentication information and the data transmission schema; and
storing the authentication information and data transmission schema.

33. The method of claim 31 wherein the client identifier information includes location information and further comprising receiving from the service component tax information indicative of a tax jurisdiction associated with the location information.

34. A payroll generation system, comprising:
a client component configured to receive a user input requesting generation of the payment information for an identified entity, and extract, from a data store, identification information identifying an entity to receive the payment and basis information indicative of a basis for the payment; and
a service component, remote from the client component, configured to receive the extracted information from the client component, generate the payment information based on the identification information and the basis information, and return the payment information to the client component.

35. The system of claim 34 wherein the client component is configured to transmit the extracted information to the service component by populating a data transmission schema with the extracted information, and transmitting the populated data transmission schema to the service component.

36. The system of claim 35 wherein the client component is further configured to download any updated data transmission schema required by the client component prior to populating the data transmission schema.

37. The system of claim 34 wherein the basis information comprises rate information indicative of a payment rate for the identified entity and time information indicative of an amount of time to which to apply the payment rate to obtain a gross pay associated with the identified entity and wherein the service component is configured to calculate the gross pay associated with the identified entity.

38. The system of claim 37 wherein the service component is configured to adjust the gross pay based on received adjustment information indicative of adjustments to be made to the gross pay associated with the identified entity.

39. The system of claim 38 wherein the service component is configured to adjust the gross pay by invoking a tax calculator component to calculate taxes based on a received tax identifier identifying a tax treatment for the identified entity.
